(19) United States
(12) Patent Application Publication
(10) Pub. No.: US 2011/0005364 A1
(43) Pub. Date: Jan. 13, 2011

(54) Band saw having worktable whose horizontal rotary angle is adjustable

(75) Inventors: Hsuan-Chu Liu, Taichung County (TW); Hung-Chi Chen, Taichuing County (TW)

Correspondence Address: BACON & THOMAS, PLLC, 625 SLATERS LANE, FOURTH FLOOR, ALEXANDRIA, VA, 22314-1176, US

(73) Assignee: OAV EQUIPMENT & TOOLS, INC., TAICHUNG COUNTY (TW)

(21) Appl. No.: 12/585,256

(22) Filed: Sep. 10, 2009

(30) Foreign Application Priority Data
Jul. 10, 2009 (TW) 98123538

(51) Int. Cl. B26D 1/46; B27B 13/04

(52) U.S. Cl. 83/810; 83/802

(57) ABSTRACT

A band saw includes a machine base having a shaft hole for a saw blade to pass through, and a worktable having a shaft tube for the saw blade to pass through. By means of the insertion of the shaft tube of the worktable into the shaft hole of the machine base, the worktable is rotatable relative to the saw blade for adjustment of the horizontal rotary angle thereof.

### BACKGROUND OF THE INVENTION

1. Field of the Invention

The present invention relates generally to a band saw, and more specifically to a band saw having a worktable whose horizontal rotary angle is adjustable according to the deflection angle of a saw blade.

2. Description of the Related Art

When operating a band saw for cutting a workpiece, an operator places a workpiece on a worktable and then forcibly pushes the workpiece toward a saw blade for cutting. However, the saw blade is subject to slight deflection to fail to cut the workpiece in a straight line during sawing because of the operator's improper use or the wear of the saw blade.

Under the circumstances, the operator may replace the saw blade before continuing to work, but such replacement will take a long time and increase the production cost. Besides, a new saw blade may have the aforesaid drawback because of either of its manufacturing defects.

### SUMMARY OF THE INVENTION

It is one objective of the present invention to provide a band saw having a worktable whose horizontal rotary angle is adjustable to allow cutting a workpiece in a straight line in spite of the deflection of a saw blade.

To achieve this objective of the present invention, the band saw comprises a machine base having a shaft hole, a saw blade disposed in the machine base and passing through the shaft hole of the machine base, and a worktable having a shaft tube rotatably inserted into the shaft hole of the machine base for insertion of the saw blade such that the worktable is rotatable relative to the saw blade through the rotation of the shaft tube.

In a preferred embodiment of the present invention, the shaft hole can be integrally formed on the machine base or provided on a retaining plate of the machine base, and the shaft tube can be integrally formed on a bottom bracket of the worktable or provided on an adjustment plate mounted on the bottom bracket of the worktable.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a partially exploded view of a band saw according to a first preferred embodiment of the prevent invention;

FIG. 2 is an enlarged view of a part of the band saw according to the first preferred embodiment of the prevent invention;

FIG. 3 is a front view of the band saw according to the first preferred embodiment of the prevent invention;

FIG. 4 is a partial top view of the band saw according to the first preferred embodiment of the prevent invention, showing the worktable is not rotated;

FIG. 5 is similar to FIG. 4, showing the worktable is rotated;

FIG. 6 is a partially exploded view of the band saw according to a second preferred embodiment of the prevent invention, and

FIG. 7 is a front view of the band saw according to the second preferred embodiment of the prevent invention.

### DETAILED DESCRIPTION OF THE INVENTION

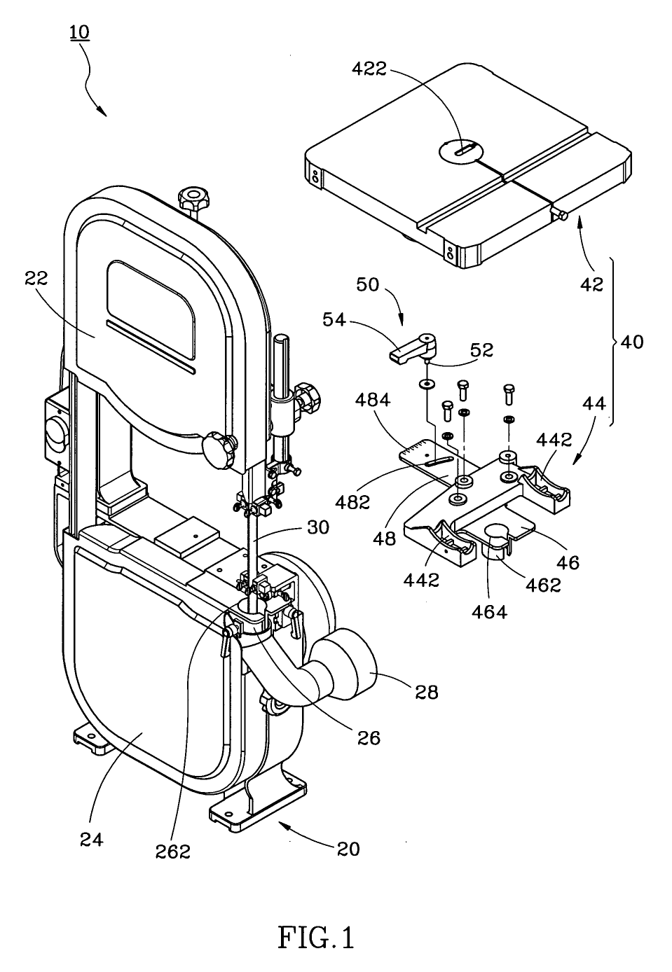

Referring to FIG. 1, a band saw 10 in accordance with a first preferred embodiment of the present invention comprises a machine base 20, a saw blade 30, a worktable 40, and a stopper 50.

The machine base 20 has an upper frame 22 equipped with a driven wheel (not shown), and a lower frame 24 equipped with a driving wheel (not shown). The lower frame 24 has a first shaft tube 26 extending downwards and provided with a first shaft hole 262 at a top end thereof and a top side of the lower frame 24, and a bottom end connected with a guide tube 28 for chips of a workpiece to pass through.

The saw blade 30 is wound around the driving wheel of the lower frame 24 and the driven wheel of the upper frame 22 and passes through the shaft hole 262 of the lower frame 24 in such a way that the saw blade 30 can be driven to cut the workpiece by the driving wheel and the driven wheel.

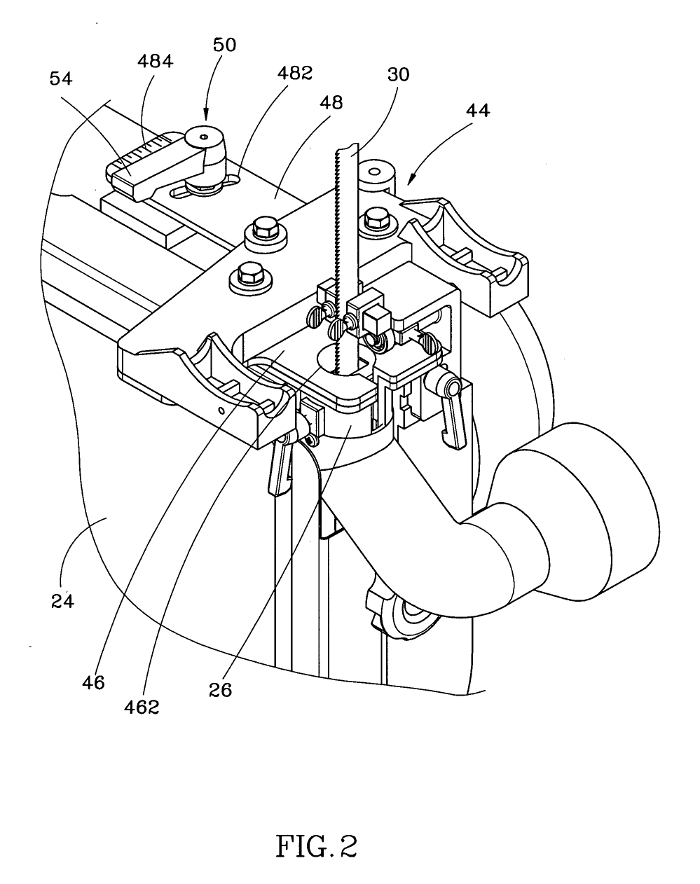

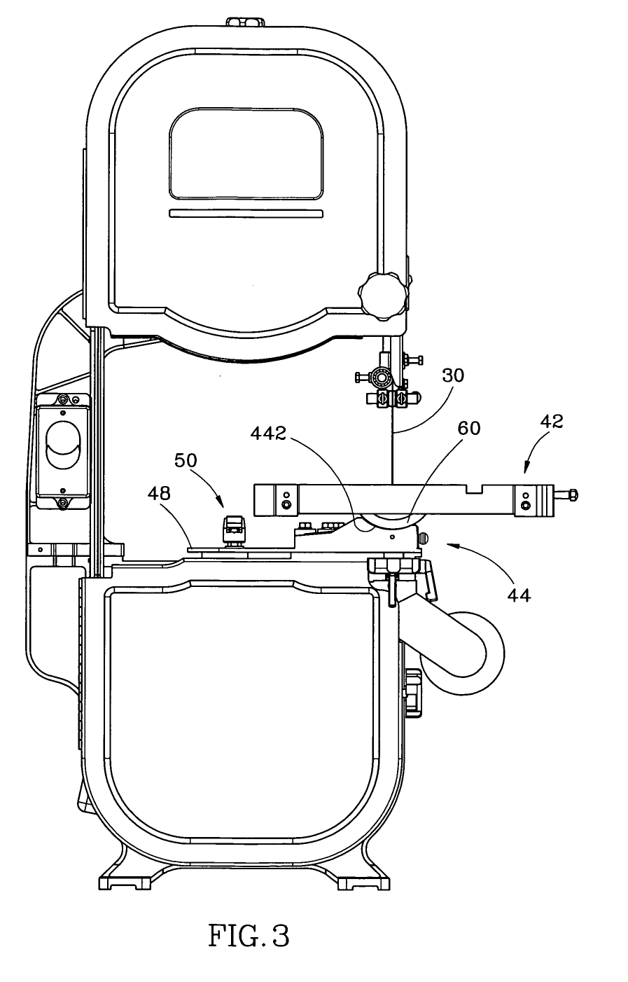

Referring to FIGS. 2 and 3 in view of FIG. 1 again, the worktable 40 has a support plate 42 for placing a to-be-cut workpiece thereon and a bottom bracket 44 mounted on a bottom side of the support plate 42. The support plate 42 has a cutting slot 422 for the saw blade 30 to pass through. The bottom bracket 44 include a head portion 46 extending forwards and and a tail portion 48 extending backwards. The head portion 46 has a second shaft tube 462 extending downwards and provided with a second shaft hole 464 at a top end thereof and a top side of the head portion 46 for allowing the saw blade 30 to pass through, and a bottom end inserted into the first shaft tube 26 through the first shaft hole 262 for allowing the worktable 40 to be rotatable relative to the saw blade 30 through the rotation of the second shaft tube 462 in the first shaft tube 26. The tail portion 48 is provided with a skewed slot 482 and graduation marks 484.

The stopper 50 has a tip 52 inserted into the skewed slot 482 of the bottom bracket 44 of the worktable 40 and stopped against the lower frame 24 of the machine frame 20 for stopping the rotation of the worktable 40; and a handle 54 which is drivable by an external force to enable the tip 52 to be stopped against or moved away from the lower frame 24.

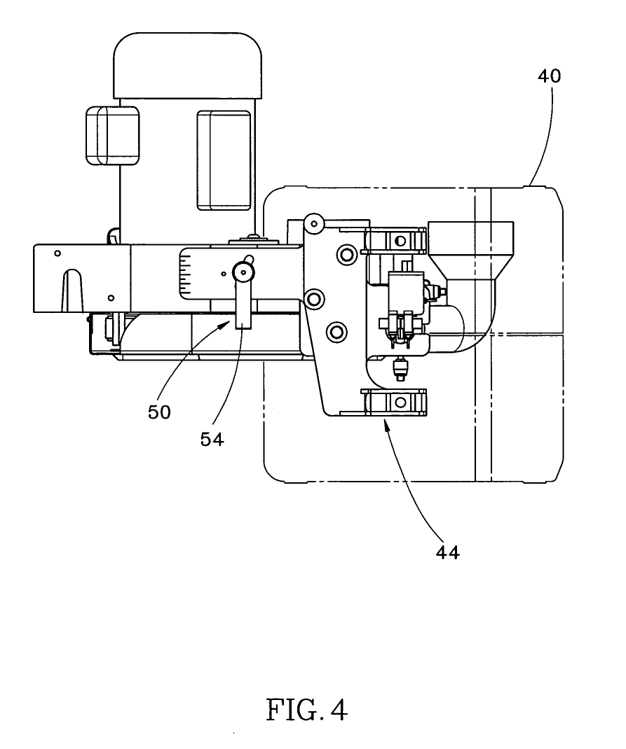

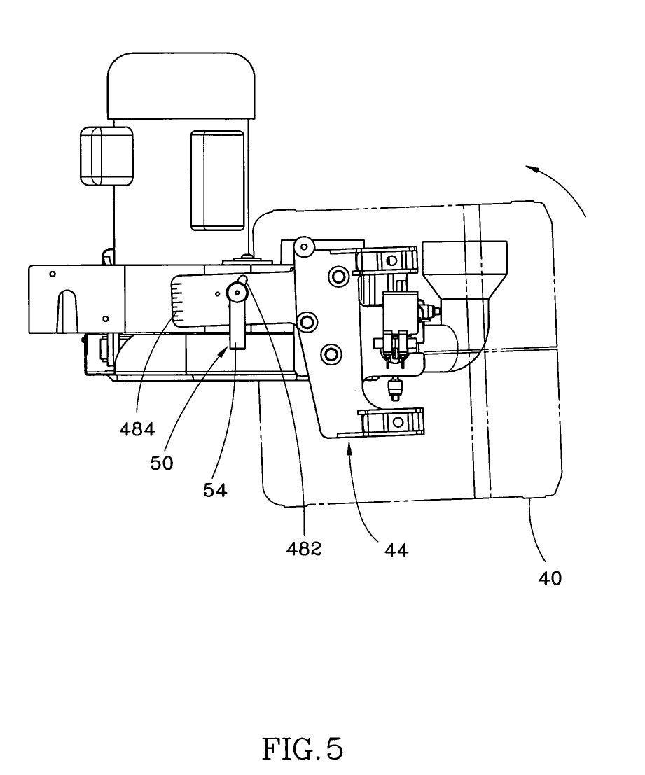

When the cutting line of the workpiece is deflected, a worker needs to measure the angle where the cutting line is deflected to learn the angle where the saw blade 30 is deflected during the cutting. Next, the worker can loosen the stopper 50 through the handle 54 to adjust the horizontal rotary angle of the worktable 40 by means of the rotation of the second shaft tube 462. During the adjustment operation of the worktable 40, the bottom bracket 44 of the worktable 40 and the stopper 50 do not interfere with each other through the skewed slot 482, and meanwhile the worker can learn the rotary angle of the worktable 40 through the graduation marks 484, as shown in FIGS. 4 and 5. Once the rotary angle of the worktable 40 is equal to the deflection angle of the saw blade 30, the worker can tighten the stopper 50 through the handle 54 to stop the rotation of the worktable 40. As a result, the workpiece can be cut in a straight line though the rotatable worktable 40 even though the saw blade 30 is deflected during the cutting, allowing the worker to continue working without replacing the saw blade 30.

As shown in FIG. 3, the worktable 40 can include two curved members 60, each of which has a top surface mounted on the bottom side of the support plate 42, and a curved surface received in one of curved grooves 442 of the bottom bracket 44 such that the support plate 42 can be deflected relative to the bottom bracket 44 through the cooperation of the curved members 60 and the curved grooves 442 for adjusting the inclination angle of the support plate 42.

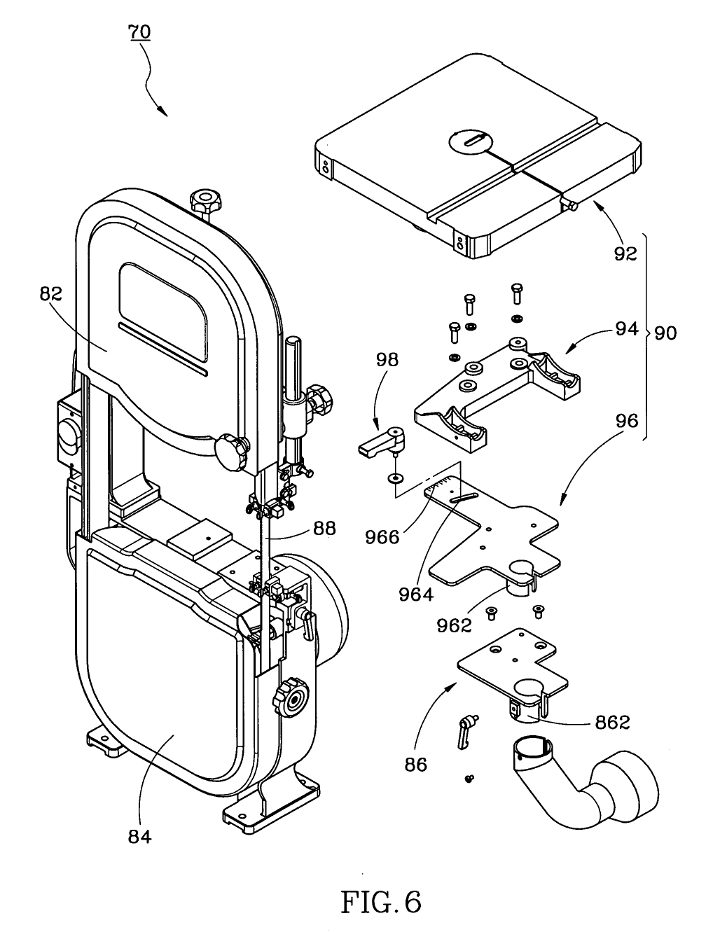

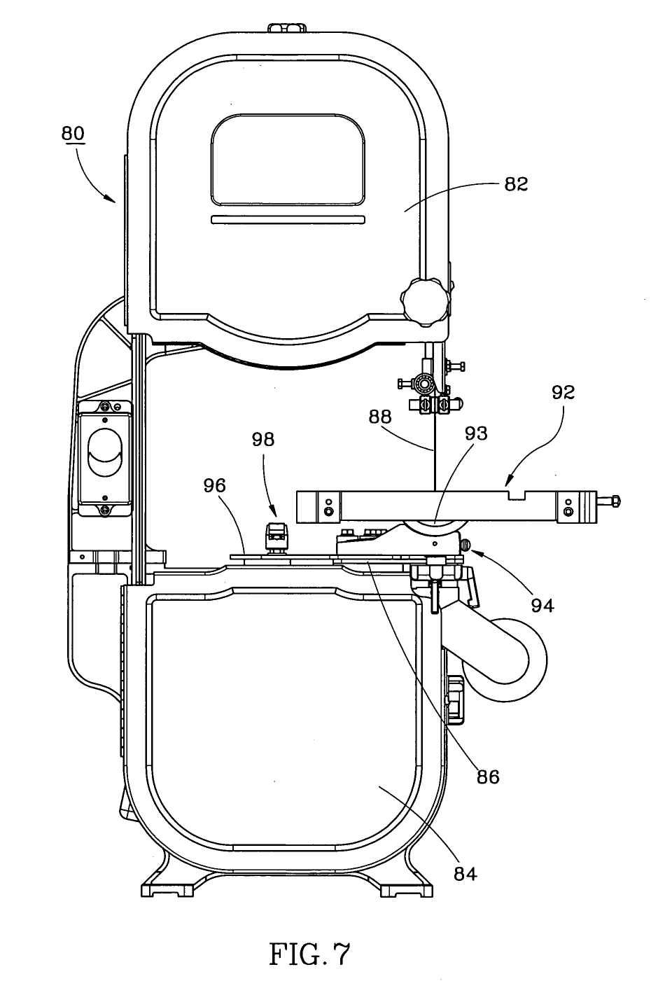

Referring to FIGS. 6 and 7, a band saw 70 in accordance with a second preferred embodiment of the present invention comprises a machine base 80 and a worktable 90.

The machine base 80 has an upper frame 82, a lower frame 84, and a retaining plate 86. The retaining plate 86 is fastened to the top side of the lower frame 84 and provided with a first shaft tube 862.

The worktable 90 has a support plate 92, a bottom bracket 94, and an adjustment plate 96. The adjustment plate 96 is fastened to the bottom side of the bottom bracket 94 and provided with a second shaft tube 962 inserted into the first shaft tube 862 at a head end thereof, and a skewed slot 964 and graduation marks 966 at a tail end thereof.

When adjusting the horizontal rotary angle of the worktable 90, the worker can loosen the stopper 98 to allow the worktable 90 to rotate by the rotation of the second shaft tube 962 of the adjustment plate 96 in the first shaft tube 862 of the retaining plate 86, and then tighten the stopper 98 to stop the rotation of the worktable 90 when the horizontal rotary angle of the worktable 90 and the deflection angle of the saw blade 30 are equal. Besides, two curved members 93 can be mounted between the support plate 92 and the bottom bracket 94 to adjust the inclination angle of the support plate 92.

As indicated above, the band saw of the present invention can adjust the horizontal rotary angle of the worktable in spite of the deflection angle of the saw blade by means of the relative rotation of two shaft tubes, thereby allowing the workpiece to be cut in a straight line even though the deflection of the saw blade may occur.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A band saw comprising:
a machine base having a shaft hole;
a saw blade disposed in the machine base and passing through the shaft hole of the machine base; and
a worktable having a shaft tube rotatably inserted into the shaft hole of the machine base for the saw blade to pass through in such a way that the worktable is rotatable relative to the saw blade through the rotation of the shaft tube.

2. The band saw as claimed in claim 1, wherein the machine base includes an upper frame and a lower frame; the shaft hole is located at the lower frame.

3. The band saw as claimed in claim 2, wherein the lower frame of the machine base has a shaft tube having a bottom end connected with a guide tube; the shaft hole is located at a top end of the shaft tube and at a top side of the lower frame.

4. The band saw as claimed in claim 1, wherein the worktable has a support plate and a bottom bracket, the bottom bracket being mounted on a bottom side of the support plate and provided with a head portion extending forwards; the shaft tube is formed at the head portion.

5. The band saw as claimed in claim 4, wherein the bottom bracket of the worktable further has a tail portion extending backwards and provided with a skewed slot for insertion of a stopper.

6. The band saw as claimed in claim 5, wherein the tail portion of the bottom bracket has graduation marks.

7. The band saw as claimed in claim 1, wherein the machine base includes an upper frame, a lower frame, and a retaining plate mounted on the lower frame; the shaft hole is located at the retaining plate.

8. The band saw as claimed in claim 7, wherein the retaining plate of the machine base has a shaft tube having a top end and a bottom end connected with a guide tube; the shaft hole is located at the top end of the machine base.

9. The band saw as claimed in claim 7, wherein the worktable has a support plate, a bottom bracket mounted on a bottom side of the support plate, and an adjustment plate mounted on a bottom side of the bottom bracket; the shaft tube is located at the adjustment plate.

10. The band saw as claimed in claim 9, wherein the adjustment plate of the worktable has a skewed slot for insertion of a stopper.

11. The band saw as claimed in claim 9, wherein the adjustment plate of the worktable has graduation marks.
